(19) United States
(12) Patent Application Publication
(10) Pub. No.: US 2012/0004930 A1
(43) Pub. Date: Jan. 5, 2012

(54) Managing and Providing Healthcare Services

(75) Inventors: Moises Cases, Austin, TX (US); Bhyrav M. Mutnury, Austin, TX (US); Scott L. Winters, Austin, TX (US)

(73) Assignee: International Business Machines Corporation, Armonk, NY (US)

(21) Appl. No.: 12/827,680

(22) Filed: Jun. 30, 2010

(51) Int. Cl. G06Q 50/00; G06Q 10/00

(52) U.S. Cl. 705/3; 705/2

(57) ABSTRACT

A method, computer program product, and apparatus for managing healthcare services are provided. A processor unit receives medical information about a patient. The processor unit generates a group of providers containing a number of providers based on the medical information received about the patient. A number of matches from the number of providers are identified for the patient using the number of providers and based on a number of criteria.

A method, computer program product, and apparatus for providing healthcare services are also provided. A processor unit receives medical information about a desired patient. The processor unit generates a group of patients containing a number of patients based on the medical information received about the desired patient. A number of matches from the number of patients are identified using the number of providers and based on a number of criteria.

### BACKGROUND

1. Field

The disclosure relates generally to an improved data processing system and more specifically to managing healthcare services in a data processing system.

2. Description of the Related Art

When a patient experiences a symptom of an illness, the patient visits a provider of healthcare to diagnose and cure the illness. Providers consist of doctors, nurse practitioners, and other suitable people that diagnose illnesses and/or render healthcare services.

The provider determines the cause of the symptoms by examining the symptoms and the medical history of the patient. The symptoms are the changes in function or feeling experienced by a patient. The medical history is a collection of previous symptoms and illnesses experienced by the patient. The medical history often also contains the treatments used on the illnesses and the result of the treatments.

To aid the provider in determining the cause of the symptoms, the provider frequently performs a number of tests on the patient. For example, the provider may order a blood test on the patient's blood to determine whether a particular item in the blood is present in abnormal levels or not present at all. Once the provider runs the tests, the provider may be able to draw a conclusion regarding the cause of the illness. However, the provider may order more tests if a conclusion may not be drawn.

Providers are commonly trained in particular areas of specialty. For example, a cardiologist is trained as a doctor, but more specifically trained in matters affecting the heart and circulatory systems of the human body. Additionally, providers become more experienced in treating particular illnesses or symptoms as the practice of the providers develops and the providers treat more patients. Thus, some providers are more qualified to treat particular illnesses than others.

A patient with a particular illness may receive more satisfactory care from a provider that is more qualified to treat the illness of the patient than a less qualified provider. The care may be more satisfactory because the illness is diagnosed and cured more quickly and with fewer complications by a qualified provider in the particular illness than a provider that has little or no experience or training in treating the particular illness.

Providers often refer patients to other providers when the provider diagnosing the patient determines that the illness of the patient is not an illness they have training and/or experience in treating. For example, the primary care physician of the patient may refer the patient to a cardiologist if a blood test shows that the patient has cholesterol that exceeds a particular value because the cardiologist has specialized training and experience in treating the excessive cholesterol.

Providers often refer patients to other providers who are known to each other through personal or professional relationships. The provider receiving the referral may be more qualified than the referring provider in treating the illness, but may focus on a different illness the patient does not have. For example, the primary care physician of a patient may refer a case of excessively high cholesterol to a cardiologist that works in the same practice group or at the same hospital as the primary care physician but concentrates primarily on treatment of ventricular tachycardia. In this example, however, there may be a cardiologist who has fifteen years of experience in treatment of excessively high cholesterol five miles away, but is not known to the primary care physician. The patient is treated by the cardiologist that is less experienced in treating excessively high cholesterol.

### SUMMARY

A method, computer program product, and apparatus for managing healthcare services are provided. A processor unit receives medical information about a patient. The processor unit generates a group of providers containing a number of providers based on the medical information received about the patient. A number of matches from the number of providers are identified for the patient using the number of providers and based on a number of criteria.

A method, computer program product, and apparatus for providing healthcare services are also provided. A processor unit receives medical information about a desired patient. The processor unit generates a group of patients containing a number of patients based on the medical information received about the desired patient. A number of matches from the number of patients are identified using the number of providers and based on a number of criteria.

### BRIEF DESCRIPTION OF THE SEVERAL VIEWS OF THE DRAWINGS

FIG. 1 depicts an illustration of a network of data processing systems in which illustrative embodiments may be implemented;

FIG. 2 depicts an illustration of a data processing system in accordance with an illustrative embodiment;

FIG. 3 depicts an illustration of a healthcare services management environment in accordance with an illustrative embodiment;

FIG. 4 depicts an illustration of a healthcare services provisioning environment in accordance with an illustrative embodiment;

FIG. 5 depicts an illustration of provider data in accordance with an illustrative embodiment;

FIG. 6 depicts an illustration of medical information in accordance with an illustrative embodiment;

FIG. 7 depicts an illustration of a number of providers in accordance with an illustrative embodiment;

FIG. 8 depicts an illustration of a visual representation for the number of providers in accordance with an illustrative embodiment;

FIG. 9 depicts a flowchart of a process for managing healthcare services in accordance with an illustrative embodiment;

FIG. 10 depicts a flowchart of an additional process for managing healthcare services in accordance with an illustrative embodiment;

FIG. 11 depicts a flowchart of a process for providing healthcare services in accordance with an illustrative embodiment;

FIG. 12 depicts a flowchart of an additional process for providing healthcare services in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

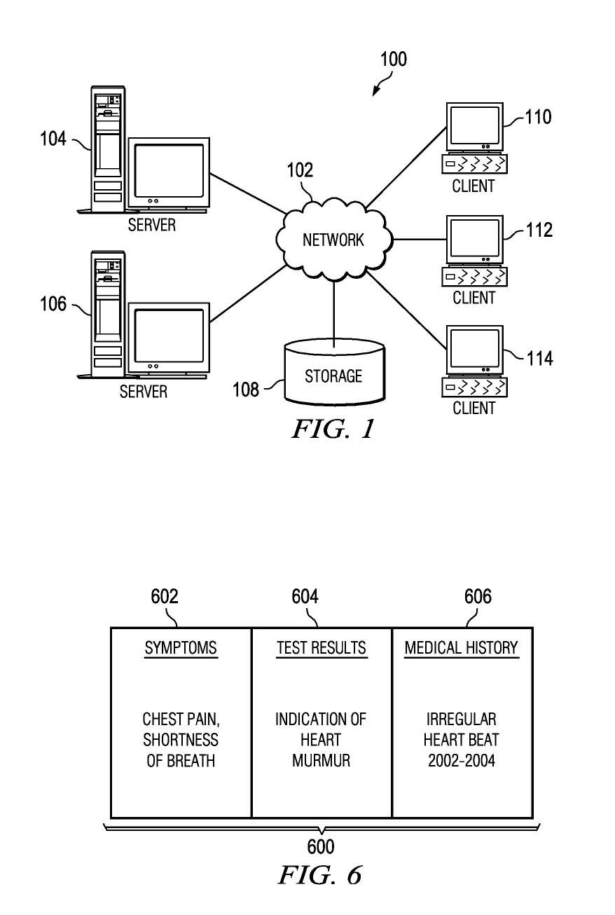

FIG. 1 depicts an illustration of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation, for the different illustrative embodiments.

Computers in network data processing system 100, such as client computer 110 and server computer 104, implement illustrative embodiments to manage healthcare services. For example, client computer 110 may request patient and/or provider data from server computer 104. Additionally, client computer 110 may request that server computer 104 generate a group of providers containing a number of providers. Client computer 110 may then request that server computer 104 generate a number of matches for a patient based on medical information for a patient and a number of criteria provided by client computer 110.

For example, client computer 110 may provide hives and dry skin as symptoms to server computer 104. Server computer 104 may generate a group of providers that contain a number of providers that have training and/or experience in treating the symptoms. Client computer 110 may then provide criteria to server computer 104, such as providers located within 50 miles of the patient but that experience is to be prioritized over location. Server computer 104 generates a number of matches that have a minimum priority based on the criteria. Of course, the group of providers and number of matches may also be generated on client computer 110 in other illustrative embodiments.

Alternatively, client computer 110 may request that server computer 104 generate a group of patients containing a number of patients based on medical information about the patient provided by client computer 110. Server computer 104 may then generate a number of matches from the number of patients based on the number of patients and a number of criteria.

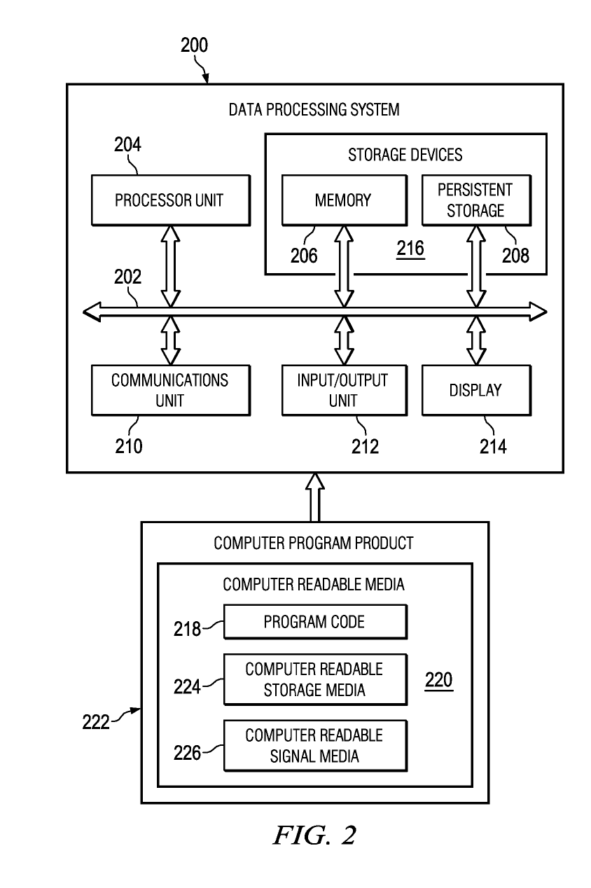

Turning now to FIG. 2, an illustration of a diagram of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system is an example implementation of server computers 104 and 106, as well as client computers 110, 112, and 114.

Processor unit 204 serves to execute instructions for software that may be loaded into memory 206. Processor unit 204 may be a number of processors, may be a multi-processor core, or some other type of processor, depending on the particular implementation. A “number”, as used herein, with reference to an item, means “one or more items”. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200. In these illustrative examples, computer readable storage media 224 is a non-transitory computer readable storage media.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, the data processing system may include organic components integrated with inorganic components, and/or may be comprised entirely of organic components, excluding a human being. For example, a storage device may be comprised of an organic semiconductor.

As another example, a storage device in data processing system 200 is any hardware apparatus that may store data. Memory 206, persistent storage 208 and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub, that may be present in communications fabric 202.

The different illustrative embodiments recognize and take into account a number of different considerations. For example, the different illustrative embodiments recognize and take into account that patients are commonly referred to healthcare providers based on factors other than the provider being the most qualified to treat the illness or the symptoms of the patient. In some examples, healthcare providers refer patients based on personal or professional relationships, such as doctors in the same practice group. The different illustrative embodiments recognize that patients are likely to receive more effective treatment from providers who are the most qualified provider to treat a particular symptom or illness than from providers who are merely the best providers known to a particular referring provider.

Additionally, the different illustrative embodiments recognize and take into account that providers frequently seek patients for medical trials or studies with particular medical histories, illnesses, or symptoms. In such illustrative embodiments, providers may generate a group of patients that have some or all of the criteria for the study. The group of patients can be prioritized based on numerous criteria, such as location, medical history, and particular test results. The providers may then receive information about the patients that meet a minimum priority level.

Thus, the different illustrative embodiments provide a method, computer program product, and apparatus for managing healthcare services. A processor unit receives medical information about a patient. The processor unit generates a group of providers containing a number of providers based on the medical information received about the patient. A number of matches from the number of providers is identified for the patient using the number of providers and based on a number of criteria.

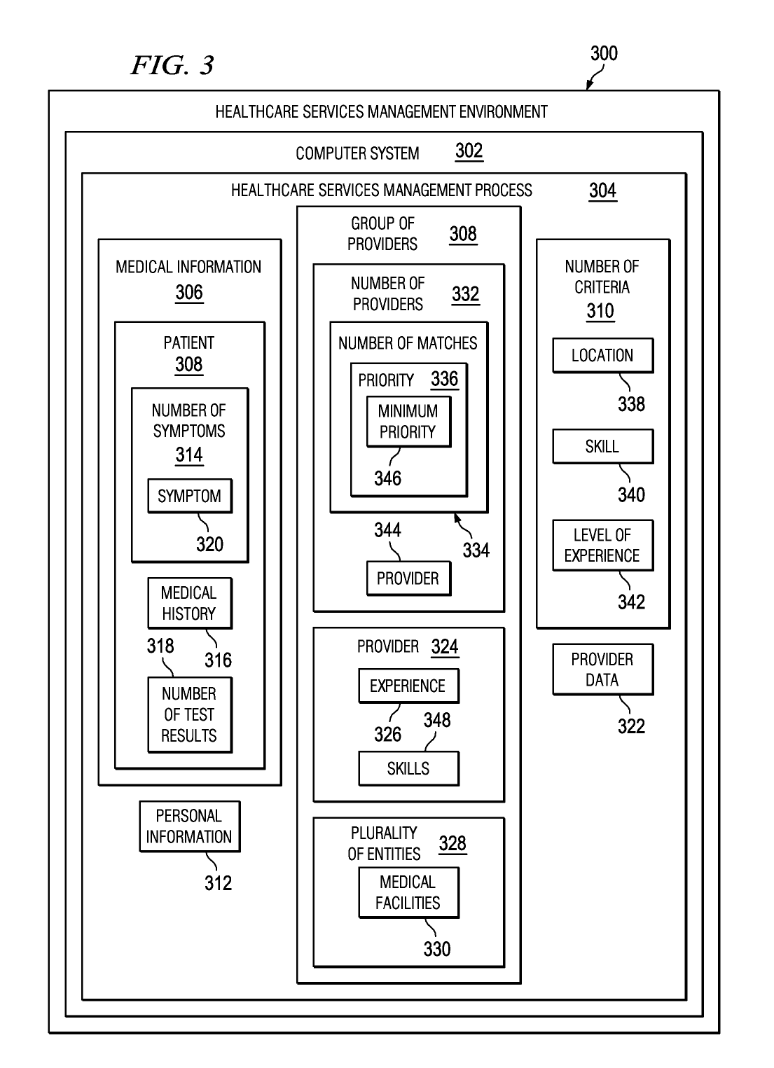

Turning now to FIG. 3, an illustration of a healthcare services management environment is depicted in accordance with an illustrative environment. Healthcare services management environment 300 may be implemented in a set of computer systems, such as server computer 104 and client computer 110 in network data processing system 100 in FIG. 1. As used herein, a set of an item means one or more of the item. For example, a set of computer systems is one or more computer systems. Of course, healthcare services management environment 300 may include additional client computers, server computers, and/or other suitable components.

In these examples, healthcare services management environment 300 contains computer system 302. Computer system 302 runs healthcare services management process 304. Healthcare services management process 304 contains medical information 306, group of providers 308, number of criteria 310, personal information 312, and provider data 322. Medical information 306 is information related to the healthcare of patient 350. For example, medical information 306 may be any combination of number of symptoms 314, medical history 316, and number of test results 318. Personal information 312 is information related to the identification and/or contact of patient 350. For example, personal information 312 includes the name, address, phone number, and social security number of patient 350.

Number of symptoms 314 are changes in function or feeling by patient 350. For example, dry skin and chest pain are both symptoms that may be in number of symptoms 314. Symptom 320 is a member of number of symptoms 314. Medical history 316 is a collection of symptoms and illnesses suffered by patient 350 and tests and treatments rendered to patient 350. In some illustrative embodiments, medical history 316 also includes illnesses suffered by family members of patient 350 with which patient 350 may share genetic tendencies.

Number of test results 318 are results obtained from testing performed on patient 350. The testing may be performed by a healthcare provider, such as a primary care physician, in response to number of symptoms 314 present in patient 350. For example, number of test results 318 may be a complete blood count that reports values for hemoglobin, white blood cell count, red blood cell count, and platelet count in the blood of patient 350.

Healthcare services management process 304 receives medical information 306. Medical information 306 may be entered by a user or retrieved from a data source. For example, the data source may be a database belonging to a primary care physician with records for the patients of the primary care physician. Responsive to receiving medical information 306, healthcare services management process 304 uses provider data 322 to generate group of providers 308. Provider data 322 is a data source containing information about healthcare providers. The information about the healthcare providers may include the name of the provider, illnesses and/or symptoms that the provider has experience treating, special skills possessed by the provider, the location of the provider, or other suitable provider information.

Healthcare services management process 304 generates group of providers 308 by processing provider data 322 and adding provider 324 to group of providers 308 when provider 324 has experience 326 treating symptom 320. In other illustrative embodiments, provider 324 is also added to group of providers 308 when provider 324 has skills 348. Skills 348 are abilities held by provider 324 or training received by provider 324 that may be beneficial to patient 350. For example, skills 348 may consist of languages spoken, additional training in a specialty, or types of treatments offered.

Number of providers 332 are providers contained in group of providers 308. For example, a physician who has treated cases of acute ankle pain has experience 326 in treating ankle pain. In some illustrative embodiments, providers in group of providers 308 are associated with plurality of entities 328. Plurality of entities 328 may be medical facilities 330. In other words, number of providers 332 in group of providers 308 may be associated with different medical facilities. The providers contained in group of providers 308 form number of providers 332.

Healthcare services management process 304 then identifies number of matches 334 in number of providers 332 using number of criteria 310. Number of criteria 310 consist of location 338, skill 340, and level of experience 342 in these examples. Location 338 is a geographic location where provider 344 practices medicine. Location 338 may be in the form of an address, a city and state, or latitude and longitude coordinates. Skill 340 is an ability held by provider 344 or training received by provider 344 that may be beneficial to patient 350. For example, skill 340 may consist of languages spoken, additional training in a specialty, or types of treatments offered. Level of experience 342 is the degree to which experience 326 is possessed by provider 344. In other words, level of experience 342 is the amount of experience 326 provider 344 has with respect to treating symptom 320.

Healthcare services management process 304 identifies number of matches 334 by assigning priority 336 to each provider 344 in number of providers 332. Priority 336 is a multidimensional priority in these examples. In other words, priority 336 consists of values for each of number of criteria 310. The values are applied to number of providers 332 to calculate a score for each of number of providers 332.

For example, the score for provider 344 may increase at a greater rate as provider 344 is located closer to patient 350 than the rate at which the score for provider 344 increases with increased level of experience 342 when priority 336 is configured to prioritize location over level of experience. Of course, additional number of criteria 310 may be present in other illustrative embodiments. In such illustrative embodiments, additional values and/or rates make up priority 336. Number of providers 332 that meet a particular minimum priority 346 are identified as number of matches 334. Number of matches 334 is returned to the requestor. In some illustrative embodiments, the requestor is patient 350, however, the requestor may also be a provider working on behalf of patient 350 or another suitable individual.

The illustration of computer system 302 in healthcare services management environment 300 is not meant to imply physical or architectural limitations to the manner in which different features may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, number of criteria 310 may include additional criteria. For example, number of criteria 310 may also include years provider 344 has practiced medicine, whether provider 344 graduated from a particular school, and the academic ranking of provider 344 in a medical school class. In such illustrative embodiments, priority 336 may contain values and/or rates for the additional criteria in number of criteria 310.

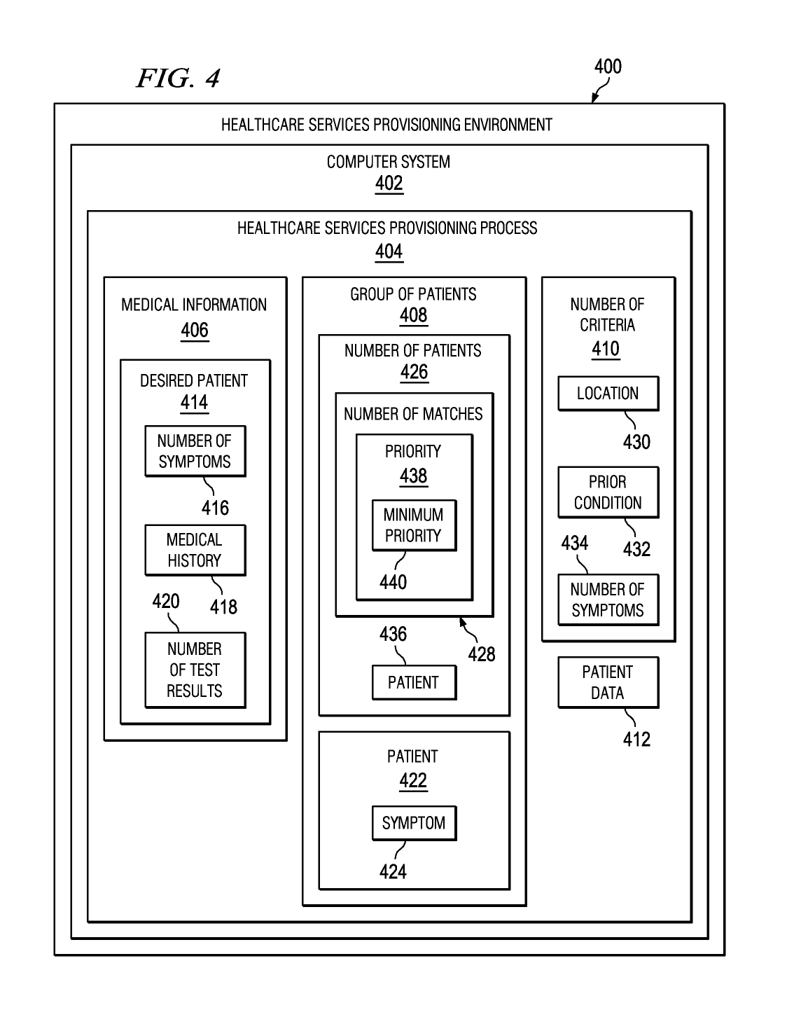

Turning now to FIG. 4, an illustration of a healthcare services provisioning environment is depicted in accordance with an illustrative embodiment. Healthcare services provisioning environment 400 may be implemented in a set of computer systems, such as server computer 104 and client computer 110 in network data processing system 100 in FIG. 1.

In these examples, healthcare services provisioning environment 400 contains computer system 402. Computer system 402 runs healthcare services provisioning process 404. Healthcare services provisioning process 404 contains medical information 406, group of patients 408, number of criteria 410, and patient data 412. Medical information 406 contains healthcare related properties desired by the requestor in desired patient 414. Desired patient 414 is a hypothetical patient that has all of the symptoms, medical history, and test results desired by the requestor for a medical study. Medical information 406 consists of number of symptoms 416, medical history 418, and number of test results 420. Number of symptoms 416 is changes in function or feeling by desired patient 414. For example, dry skin and chest pain are both symptoms that may be in number of symptoms 416. Medical history 418 is a collection of symptoms and illnesses suffered by desired patient 414 and tests and treatments rendered to desired patient 414. In some illustrative embodiments, medical history 418 also includes illnesses suffered by family members of desired patient 414 with which desired patient 414 may share genetic tendencies.

Number of test results 420 is a desired set of values or results for a number of tests in desired patient 414. For example, number of test results 420 may be a complete blood count with particular ranges of values for hemoglobin, white blood cell count, red blood cell count, and platelet count in the blood of desired patient 414.

Healthcare services provisioning process 404 receives medical information 406. Medical information 406 may be entered by a user or retrieved from a data source. For example, the data source may be a database belonging to a research physician with a set of data that should be tested during the study. Responsive to receiving medical information 406, healthcare services provisioning process 404 uses patient data 412 to generate group of patients 408. Patient data 412 is a data source containing information about patients. The information about the patients may include the name of the patient, illnesses and/or symptoms presently suffered by the patient, prior conditions, or other suitable patient data.

Healthcare services provisioning process 404 generates group of patients 408 by processing patient data 412 and adding patient 422 to group of patients 408 when patient 422 has at least symptom 424. Symptom 424 is a symptom in number of symptoms 416. Of course, in other illustrative embodiments, patient 422 may be added to group of patients 408 based on other factors, such as blood type.

Number of patients 426 are patients contained in group of patients 408. For example, patient 422 who has chronic asthma may be added to group of patients 408 when number of symptoms 416 includes chronic asthma.

Healthcare services provisioning process 404 then identifies number of matches 428 in number of patients 426 using number of criteria 410. Number of criteria 410 consist of location 430, prior condition 432, and number of symptoms 434 in these examples. Location 430 is a geographic location where patient 422 presently resides. Location 430 may consist of an address, a city and state, or latitude and longitude coordinates. Prior condition 432 is an illness from which patient 436 has suffered in the past. Patient 436 is a patient in number of patients 426. For example, prior condition 432 may be a heart attack that occurred five years ago. Number of symptoms 434 are symptoms desired by the requestor to be present in number of matches 428 in addition to number of symptoms 416.

Healthcare services provisioning proves 404 identifies number of matches 428 by assigning priority 438 to each patient 436 in number of patients 426. Priority 438 is a multidimensional priority in these examples. In other words, priority 438 consists of values for each number of criteria 410. The values are applied to number of patients 426 to calculate a score for each of number of patients 426.

For example, the score for patient 436 may increase at a greater rate as patient 436 has more of number of symptoms 434 than the rate at which the score increases as patient 436 is located nearer to requestor when priority 438 is configured to prioritize number of symptoms 434 over location 430. Of course, additional number of criteria 410 may be present in other illustrative embodiments.

In such illustrative embodiments, additional values and/or rates make up priority 438. Number of patients 426 that meet a minimum priority 440 are identified as number of matches 428. Number of matches 428 are returned to the requestor. In some illustrative embodiments, the requestor is a research physician; however, in other illustrative embodiments, the requestor is a staff member working on behalf of the research physician or another suitable individual.

The illustration of computer system 402 in healthcare services provisioning environment 400 is not meant to imply physical or architectural limitations to the manner in which different features may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, number of criteria 410 may include additional or fewer criteria. For example, number of criteria 410 may also include the age of the patient or the blood type of the patient. In such illustrative embodiments, priority 438 may contain values and/or rates for the additional criteria in number of criteria 410.

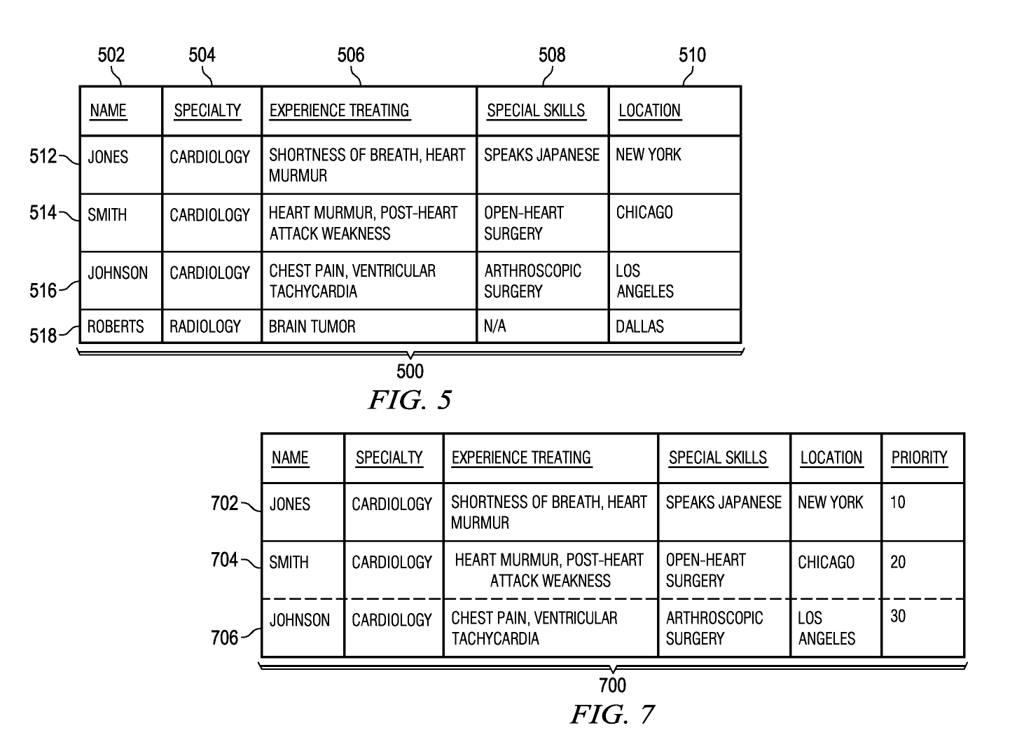

FIGS. 5-7 depict an example of managing healthcare services in accordance with an illustrative embodiment. Looking specifically at FIG. 5, an illustration of provider data is depicted in accordance with an illustrative embodiment. Provider data 500 is an example implementation of provider data 322 in FIG. 3.

Provider data 500 contains name column 502, specialty column 504, experience treating column 506, special skills column 508, and location column 510. Name column 502 indicates the name of the provider. For example, entry 512 indicates the name of the provider is Jones. Entry 514 indicates the name of the provider is Smith. Entry 516 indicates the name of the provider is Johnson. Entry 518 indicates the name of the provider is Roberts.

Specialty column 504 indicates the area of medicine in which the respective entry specializes. For example, entry 512 indicates a specialization of cardiology. Experience treating column 506 indicates the illnesses and symptoms that the provider has experience treating. Experience treating column 506 is an example implementation of experience 326 in FIG. 3. For example, entry 514 indicates that Smith has experience treating heart murmur and post-heart attack weakness.

Special skills column 508 indicates additional training or abilities possessed by the provider that may aid the patient in receiving care from the provider. Special skills column 508 is an example implementation of skills 348 in FIG. 3. For example, entry 516 indicates that Johnson possesses additional training in arthroscopic surgery.

Location column 510 indicates the geographic region in which the provider is located. For example, entry 518 indicates that Roberts practices in Dallas, Tex.

Turning now to FIG. 6, an illustration of medical information is depicted in accordance with an illustrative embodiment. Medical information 600 is an example implementation of medical information 306 in FIG. 3.

Medical information 600 consists of symptoms 602, test results 604, and medical history 606. Symptoms 602 is an example implementation of number of symptoms 314 in FIG. 3. Test results 604 is an example implementation of number of test results 318 in FIG. 3. Medical history 606 is an example implementation of medical history 316 in FIG. 3.

In this illustrative example, symptoms 602 indicate that the patient is experiencing shortness of breath and chest pain. Test results 604 indicate that a heart murmur may be present. The test that provided test results 604 was performed by the primary care physician of the patient. Medical history 606 indicates that the patient experienced irregular heartbeat between 2002 and 2004.

Looking specifically at FIG. 7, an illustration of a number of providers is depicted in accordance with an illustrative embodiment. Number of providers 700 is an example implementation of number of providers 332 in FIG. 3.

Number of providers 700 is the result of a process, such as healthcare services management process 304, generating a group of providers using medical information 600 in FIG. 6. In this illustrative example, entries 702, 704 and 706 are in number of providers 700. Entry 702 is in number of providers 700 because the provider represented by entry 702 has experience treating shortness of breath and heart murmur. Symptoms 602 in FIG. 6 indicated that the patient was experiencing chest pain and shortness of breath.

Entry 704 is in number of providers 700 because the provider represented by entry 704 has experience treating heart murmur. Entry 706 is present in number of providers 700 because the provider represented by entry 706 has experience treating chest pain. Chest pain and heart murmur were present in symptoms 602 in FIG. 6.

The process then identifies a number of matches, such as number of matches 334 in FIG. 3, from number of providers 700. In this example, assume that a priority closer to zero is preferable to a priority farther from zero, and that the minimum priority is 20. Thus, entries with a priority of 20 or lower are included in the number of matches, while entries above a priority of 20 are not included in the number of matches.

In this illustrative example, experience treating the heart murmur condition shown in the test results of the patient is given the highest priority, followed by the shortness of breath symptom, followed by location. Since entry 702 has experience treating heart murmur and shortness of breath, entry 702 receives the most preferable priority of 10. Entry 704 has experience treating heart murmur but not chest pain. Since experience treating heart murmur is a higher priority than location, however, entry 704 receives second priority at 20. Finally, entry 706 receives priority of 30 regardless of the geographic proximity between Sacramento and Los Angeles because entry 706 only has experience treating chest pain. Since entry 706 does not meet the minimum priority of 20, entry 706 is not included in the number of matches returned to the requestor. Entry 702 and entry 704 are returned to the requestor as the number of matches.

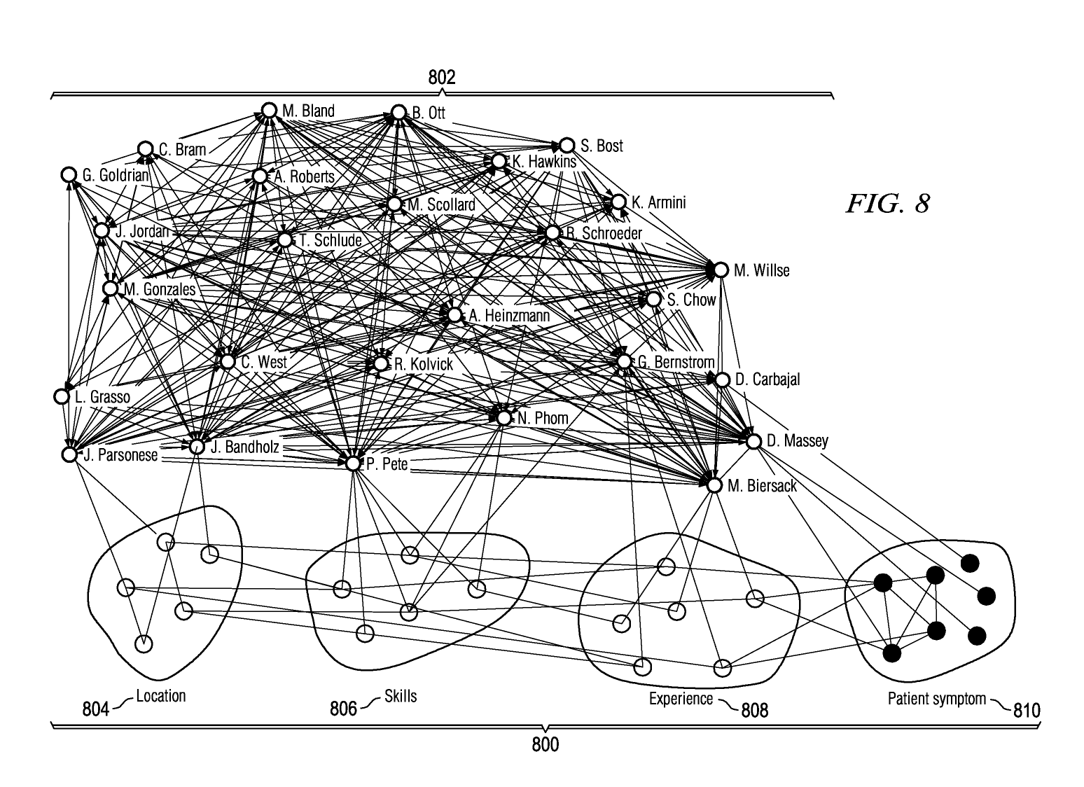

Looking specifically at FIG. 8, an illustration of a visual representation for the number of providers is depicted in accordance with an illustrative embodiment. Number of providers 800 is an example implementation of group of providers 308 in FIG. 3.

Number of providers 800 is a visual representation of the providers that have experience treating at least one of the symptoms experienced by a patient. Data 802 represents the providers in number of providers 800. The links between the providers in data 802 represent levels of experience, skills, or locations in common with the provider with whom the link is shared.

Categories 804-810 are a visual representation of the providers that meet the criteria established in the respective categories. For example, category 804 represents the providers that meet the location criteria for the patient. Category 806 represents the providers that meet the skills criteria for the patient. For example, category 806 may contain the providers in number of providers 800 that possess training in open-heart surgery. Category 808 represents the providers that meet the experience criteria for the patient. For example, category 808 may contain the providers in number of providers 800 that have treated at least 100 cases of ventrical failure. Category 810 represents the providers that have experience treating the symptoms of the patient. For example, category 810 may contain the providers in number of providers 800 that have experience treating all the symptoms being experienced by the patient. Categories 804-810 are used to determine the priorities for the number of matches, such as priority 336 in FIG. 3.

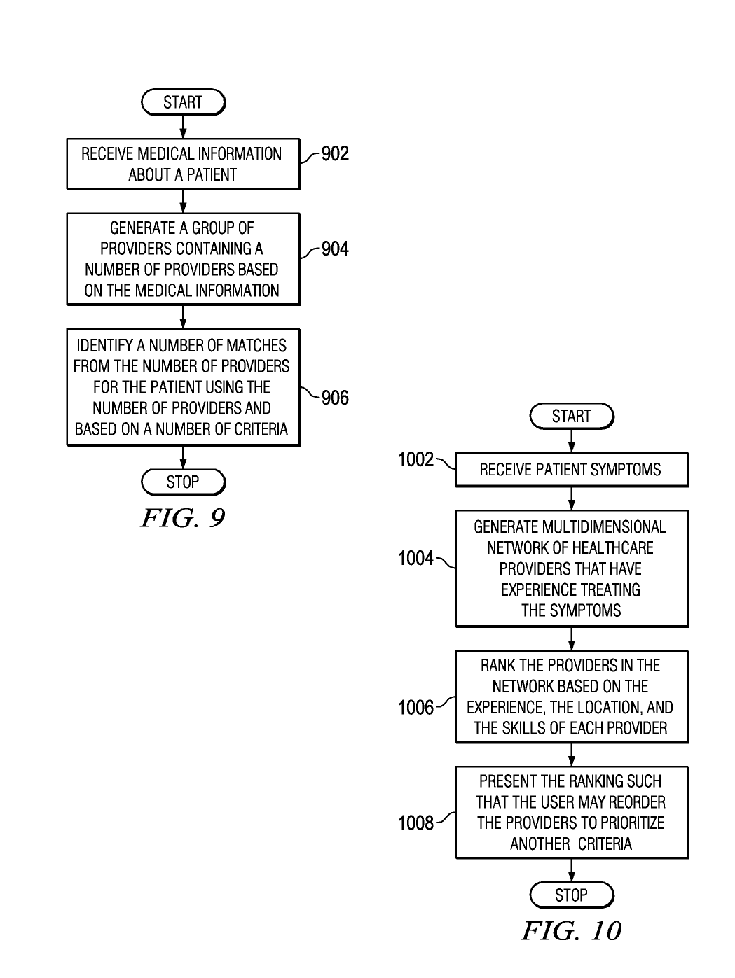

Turning now to FIG. 9, a flowchart of a process for managing healthcare services is depicted in accordance with an illustrative embodiment. The process may be performed by healthcare services management process 304 running on computer system 302 in FIG. 3.

The process begins by receiving medical information about a patient (step 902). The medical information may consist of any combination of a number of symptoms, a medical history, and a number of test results. The process then generates a group of providers containing a number of providers based on the medical information (step 904). The group of providers may be generated from a data source, such as provider data 322 in FIG. 3, and may contain information about providers in a particular geographical region or a particular insurance network. Alternatively, the data source may contain information about all known global providers. The number of providers may be providers that have at least one common element with the medical information. For example, a provider may be in the number of providers if the provider has experience in treating ventricular tachycardia, and the medical information of the patient states the patient has had ventricular tachycardia in the past.

The process then identifies a number of matches from the number of providers for the patient using the number of providers and based on a number of criteria (step 906). The number of matches is providers in the number of providers that have at least a minimum priority. The priority of the number of providers is determined by processing the priorities of the patient. The priorities of the patient may be multidimensional in nature. For example, the priorities of the patient may be location and skills, followed by experience and specialty. The process terminates thereafter.

Looking specifically at FIG. 10, an additional process for managing healthcare services is depicted in accordance with an illustrative embodiment. The process may be performed by healthcare services management process 304 running on computer system 302 in FIG. 3.

The process begins by receiving patient symptoms (step 1002). For example, the patient symptoms may be dry skin and hives. The process then generates a multidimensional network of healthcare providers that have experience treating the symptoms (step 1004). The multidimensional network of healthcare providers is an example implementation of group of providers 308 in FIG. 3.

The process then ranks the providers in the network based on the experience, the location, and the skills of each provider (step 1006). The ranking may be based on priorities provided by the patient. For example, the patient may prioritize location and skills of a provider over experience and specialty of the provider.

The process then presents the ranking such that the user may reorder the providers to prioritize another criteria (step 1008). For example, the process may present a button near a particular criteria that may be activated by the user. When the button is activated by the user, the nearby criteria is increased in priority and the providers are reordered according to the new priorities. The process terminates thereafter.

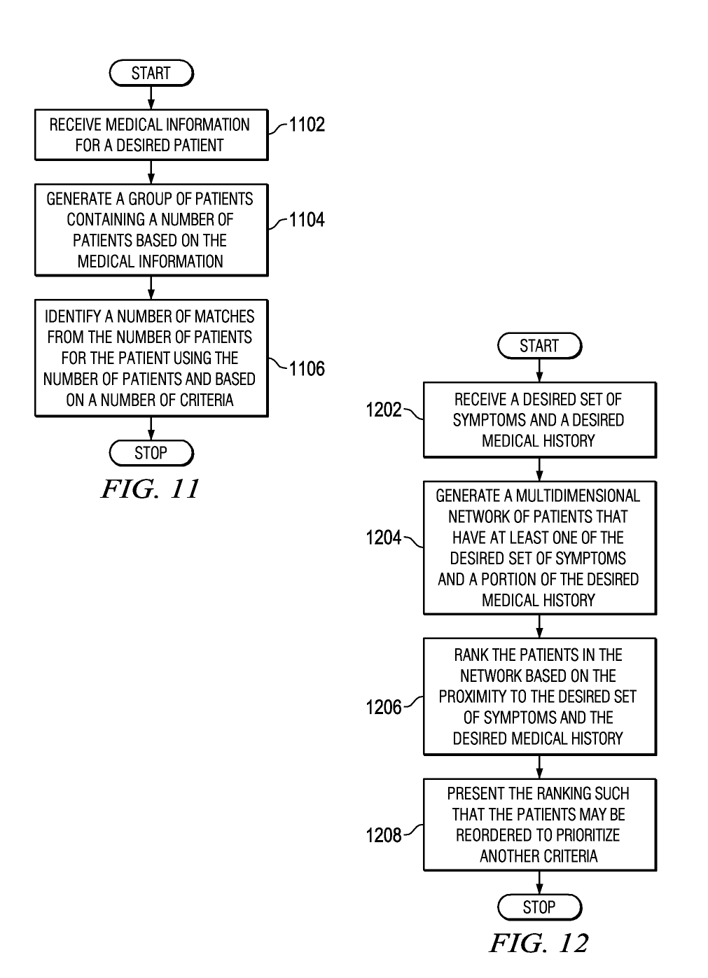

Turning now to FIG. 11, a flowchart of a process for providing healthcare services is depicted in accordance with an illustrative embodiment. The process may be performed by healthcare services provisioning process 404 running on computer system 402 in FIG. 4.

The process begins by receiving medical information for a desired patient (step 1102). The medical information may consist of any combination of a number of symptoms, a medical history and a number of test results. The process then generates a group of patients containing a number of patients based on the medical information (step 1104). The group of patients may be generated from a data source, such as patient data 412 in FIG. 4 containing information about patients in a particular geographical region or a particular insurance network. Alternatively, the data source may contain information about all known global patients. The number of patients may be patients that have at least one common element with the medical information. For example, a patient may be in the number of patient if the desired patient has prior history of ventricular tachycardia, and the medical information of the desired patient states the patient has had ventricular tachycardia in the past.

The process then identifies a number of matches from the number of patients for the patient using the number of patients and based on a number of criteria (step 1106). The number of matches is providers in the number of patients that have at least a minimum priority. The priority of the number of patients is determined by processing the priorities of the requestor. The priorities of the requestor may be multidimensional in nature. For example, the priorities of the requestor may be location and skills, followed by experience and specialty. The process terminates thereafter.

Looking specifically at FIG. 12, a flowchart of an additional process for providing healthcare services is depicted in accordance with an illustrative embodiment. The process may be performed by healthcare services provisioning process 404 running on computer system 402 in FIG. 4.

The process begins by receiving a desired set of symptoms and a desired medical history (step 1202). For example, the desired set of symptoms may be dry skin and hives and the desired medical history may include family history of skin cancer. The process then generates a multidimensional network of patients that have at least one of the desired set of symptoms and a portion of the desired medical history (step 1204). The multidimensional network of patients is an example implementation of group of patients 408 in FIG. 4.

The process then ranks the patients in the network based on the proximity to the desired set of symptoms and the desired medical history (step 1006). Proximity is a degree of likeness between the symptoms of the patient and the desired set of symptoms, as well as between the desired medical history and the medical history of the patient. For example, assume the desired set of symptoms are dry skin, hives, and the desired medical history is a family history of skin cancer. A patient with the symptom of dry skin and a family history of skin cancer does not have as high a proximity to the desired set of symptoms and the desired medical history of the patient as a patient with dry skin, hives, and a family history of skin cancer.

The ranking may be based on priorities provided by the requestor. For example, the requestor may prioritize location and symptoms of a patient over medical history.

The process then presents the ranking such that the patients may be reordered to prioritize another criteria (step 1008). For example, the process may present a button near a particular criteria that may be activated by the requestor. When the button is activated by the requestor, the nearby criteria is increased in priority and the providers are reordered according to the new priorities. The process terminates thereafter.

The flowchart and block diagrams in the different depicted embodiments illustrate the architecture, functionality, and operation of some possible implementations of apparatus and methods in different illustrative embodiments. In this regard, each block in the flowchart or block diagrams may represent a module, segment, function, and/or a portion of an operation or step.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved. Also, other blocks may be added in addition to the illustrated blocks in a flowchart or block diagram.

For example, the process may receive a number of priorities for the number of matches with the medical information in step 902. Alternatively, the number of priorities may be preconfigured to default values. Likewise, the process may receive a number of priorities for the number of matches with the medical information in step 1102. Alternatively, the number of priorities may be preconfigured to default values.

The process may also receive desired skills with the patient symptoms in step 1002. The process may use the desired skills in generating the multidimensional network at step 1004. For example, the desired skill may be that the provider speaks Japanese. In such an illustrative example, the process generates the multidimensional network of healthcare providers that have experience treating the symptoms but also speak Japanese at step 1004.

Thus, the different illustrative embodiments allow a patient to be treated by the doctor that is best suited for treating the illness or symptom suffered by the patient. Providers may make referrals to other providers based on factors other than personal or professional relationships. Patient treatment may be conducted by the provider who has the most experience, is geographically closest, has particular skills, or any combination thereof.

Additionally, the different illustrative embodiments allow patients desirable to providers conducting a medical study to be identified to the providers without reaching the patient through advertisement to apply to the study. Reliability of study data is improved over studies in which providers simply wait for patients to apply because a targeted medical history and number of symptoms may be located in a number of patients. The number of patients may then be contacted to determine whether they are interested in participating in the study.

Thus, the different illustrative embodiments provide a method, computer program product, and apparatus for managing healthcare services. A processor unit receives medical information about a patient. The processor unit generates a group of providers containing a number of providers based on the medical information received about the patient. A number of matches from the number of providers is identified for the patient using the number of providers and based on a number of criteria.

The different illustrative embodiments also provide a method, computer program product, and apparatus for providing healthcare services. A processor unit receives medical information about a desired patient. The processor unit generates a group of patients containing a number of patients based on the medical information received about the desired patient. A number of matches from the number of patients is identified using the number of providers and based on a number of criteria.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of managing healthcare services comprising:
receiving, by a processor unit, medical information about a patient;
generating, by the processor unit, a group of providers containing a number of providers based on the medical information received about the patient; and
identifying a number of matches from the number of providers for the patient using the number of providers and based on a number of criteria.

2. The method of claim 1, wherein the medical information is selected from a number of symptoms, a medical history, and a number of test results.

3. The method of claim 2, wherein the step of generating the group of providers containing the number of providers further comprises:
determining whether a provider has experience in treating a symptom in the number of symptoms; and
responsive to a determination that the provider has experience in the number of symptoms, adding the provider to the group of providers.

4. The method of claim 1, wherein the number of criteria are selected from a location of a provider in the number of providers, a skill possessed by the provider, a level of experience possessed by the provider, and the number of symptoms.

5. The method of claim 4, wherein the step of identifying the number of matches from the number of providers for the patient using the number of providers and based on the number of criteria further comprises:
assigning a priority to each of the number of providers based on the number of criteria; and
identifying the number of providers with a minimum priority to form the number of matches.

6. The method of claim 1, wherein the group of providers are associated with a plurality of entities.

7. The method of claim 6, wherein the plurality of entities are medical facilities.

8. The method of claim 1 further comprising:
presenting the number of matches with the number of criteria.

9. A method of providing healthcare services comprising:
receiving, by a processor unit, medical information for a desired patient;
generating, by the processor unit, a group of patients containing a number of patients based on the medical information received about the desired patient;
identifying a number of matches from the number of patients using the number of patients and based on a number of criteria.

10. The method of claim 9, wherein the medical information is selected from a number of symptoms, a medical history, and a number of test results.

11. The method of claim 10, wherein the step of generating the group of patients containing the number of patients further comprises:
determining whether a patient has experienced a symptom in the number of symptoms; and
responsive to a determination that the patient has experienced the symptom, adding the patient to the group of patients.

12. The method of claim 9, wherein the number of criteria are selected from a location of a patient in the number of patients, a prior condition experienced by the patient, a prior treatment received by the patient, and the number of symptoms.

13. The method of claim 12, wherein the step of identifying the number of matches from the number of patients using the number of patients and based on the number of criteria further comprises:
assigning a priority to each of the number of patients based on the number of criteria; and
identifying the number of patients with a minimum priority to form the number of matches.

14. A computer program product comprising:
a computer readable storage medium;
computer readable program code, stored on the computer readable storage medium, for receiving medical information about a patient;
computer readable program code, stored on the computer readable storage medium, for generating a group of providers containing a number of providers based on the medical information received about the patient; and
computer readable program code, stored on the computer readable storage medium, for identifying a number of matches from the number of providers for the patient using the number of providers and based on a number of criteria.

15. The computer program product of claim 14, wherein the medical information is selected from a number of symptoms, a medical history, and a number of test results.

16. The computer program product of claim 15, wherein the program code for generating the group of providers containing the number of providers further comprises:
program code, stored on the computer readable storage medium, for determining whether a provider has experience in treating a symptom in the number of symptoms; and
program code, stored on the computer readable storage medium, for adding the provider to the group of providers responsive to a determination that the provider has experience in the number of symptoms.

17. The computer program product of claim 14, wherein the number of criteria are selected from a location of a provider in the number of providers, a skill possessed by the provider, a level of experience possessed by the provider, and the number of symptoms.

18. The computer program product of claim 17, wherein the program code for identifying the number of matches from the number of providers for the patient using the number of providers and based on the number of criteria further comprises:
program code, stored on the computer readable storage medium, for assigning a priority to each of the number of providers based on the number of criteria; and
program code, stored on the computer readable storage medium, for identifying the number of providers with a minimum priority to form the number of matches.

19. The computer program product of claim 14, wherein the group of providers are associated with a plurality of entities.

20. The computer program product of claim 19, wherein the plurality of entities are medical facilities.
